(19) United States
(12) Patent Application Publication
(10) Pub. No.: US 2015/0260360 A1
(43) Pub. Date: Sep. 17, 2015

(54) ARRAY SUBSTRATE AND DISPLAY DEVICE

(71) Applicants: BOE Technology Group Co., Ltd., Beijing (CN); Chengdu BOE Optoelectronics Technology Co., Ltd., Chengdu (CN)

(72) Inventors: Kun Li, Beijing (CN); Feng Bai, Beijing (CN); Ko YoungYik, Beijing (CN); Zhiqin Zhang, Beijing (CN)

(21) Appl. No.: 14/312,896

(22) Filed: Jun. 24, 2014

(30) Foreign Application Priority Data
Mar. 17, 2014 (CN) 201410099167.8

(51) Int. Cl. F21L 4/08; F21V 7/00; G02F 1/133

(52) U.S. Cl. CPC F21L 4/08; G02F 1/13306; F21V 7/00; G02F 2001/13312

(57) ABSTRACT

An array substrate and a display device are disclosed. The array substrate comprises a backlight source for emitting light; a substrate including a reflection region configured to reflect an external light and a transmission region configured to transmit a light emitted by the backlight source; and a photoelectric conversion device disposed on the substrate and configured to convert optical energy of the light emitted to the reflection region into electric energy. Energy of the light incident on a reflection region of a transflective liquid display device is recycled, thereby avoiding wasting part of energy from the backlight source. Meanwhile, the display device comprises the above mentioned array substrate. This display device is in particular used in smart mobile terminal equipments such as smart watch and the likes.

### CROSS-REFERENCE TO RELATED APPLICATION

This application claims the benefit of Chinese Patent Application No. 201410099167.8 filed on Mar. 17, 2014 in the State Intellectual Property Office of China, the whole disclosure of which is incorporated herein by reference.

### BACKGROUND OF THE INVENTION

1. Field of the Invention

The present invention relate to liquid crystal display technology, and more particularly, to an array substrate and a display device having the same.

2. Description of the Related Art

There are three types of liquid crystal display devices according to their receiving light modes, that is, a transmission type, a reflection type and a transflective type.

A transmissive display device performs the display function by transmitting light from a backlight source. However, in a strong light source environment such as outdoor environment, images displayed on the display screen became blurry because the display screen is too bright due to interference of external light on intensity of the backlight source. A reflective display device performs the display function by reflecting the external light, which requires no backlight and thus has lower power consumption than the transmission type display device. However; in a poor light environment such as indoor environment or at night, the light intensity is usually insufficient, thereby bringing unfavorable display effect. A transflective display device has advantages of both of the foregoing display devices and in which each pixel is divided into a reflection region where the display function is performed by transmitting the light from the backlight source and a reflection region where the display function is performed by reflecting the external light. Accordingly, the transflective display device has good display effect regardless of strong or poor light environment.

In the transflective display device, light from the backlight source is incident evenly on the entire display region, but, in the reflection region, light cannot pass through the reflection layer where the external light is reflected. In this way, the light incident onto the reflection region from the backlight source is not utilized to perform the display function and is wasted. Accordingly, in other words, part of electrical energy of the backlight source is wasted in the transflective display device. Furthermore, the more the size of the display screen is, the more the waste of the energy in the reflection region is.

### SUMMARY OF THE INVENTION

In view of the above, at least one object of the embodiments of the present invention is to provide an array substrate and a display device, which can recycle energy of the light incident on a reflection region of a transflective liquid display device, and avoid wasting part of energy from the backlight source.

According to an embodiment of one aspect of the present invention, there is provided an array substrate comprises a backlight source for emitting light; a substrate including a reflection region configured to reflect an external light and a transmission region configured to transmit a light emitted by the backlight source; and a photoelectric conversion device disposed on the substrate and configured for photoelectric conversion of optical energy of the light emitted to the reflection region into electric energy.

According to an embodiment of a further aspect of the present invention, there is provided a display device comprising the abovementioned array substrate.

### BRIEF DESCRIPTION OF THE DRAWINGS

The above and other features of the present invention will become more apparent by describing in detail exemplary embodiments thereof with reference to the accompanying drawings, in which:

FIG. 1 is a cross-sectional view of a transflective display panel including an array substrate according to a first exemplary embodiment of the present invention;

FIG. 2 is a cross-sectional view of a transflective display panel including an array substrate according to a second exemplary embodiment of the present invention;

FIG. 3 is a cross-sectional view of a transflective display panel including an array substrate according to a third exemplary embodiment of the present invention;

FIG. 4 is a cross-sectional view of a transflective display panel including an array substrate according to a fourth exemplary embodiment of the present invention;

FIG. 5 is a cross-sectional view of a transflective display panel including an array substrate according to a fifth exemplary embodiment of the present invention;

FIG. 6 is a cross-sectional view of a transflective display panel including an array substrate according to a sixth exemplary embodiment of the present invention;

FIG. 7 is a schematic plan view showing an arrangement of transmission region/reflection region/shading region in a pixel region of the transflective display panel according to the above mentioned embodiments of the present invention; and

FIG. 8 is a schematic plan view showing an arrangement of transmission region/reflection region/shading region in a pixel area of a transflective display panel in the prior art.

### DETAILED DESCRIPTION OF PREFERRED EMBODIMENTS OF THE INVENTION

Exemplary embodiments of the present invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the present invention will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided an array substrate comprising: a backlight source for emitting light; a substrate including a reflection region configured to reflect an external light and a transmission region configured to transmit a light emitted by the backlight source; and a photoelectric conversion device disposed on the substrate and configured to convert optical energy of the light emitted to the reflection region from the backlight source into electric energy.

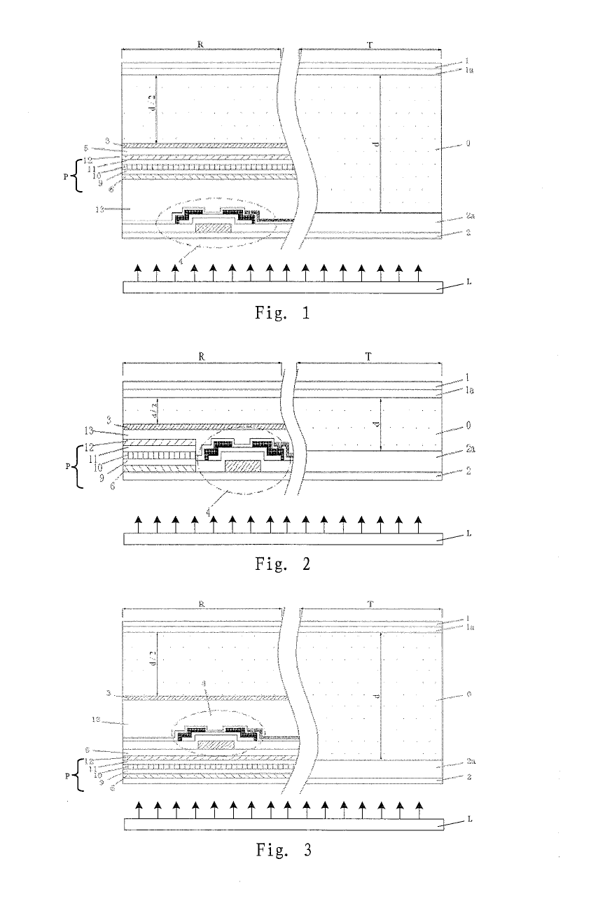

FIG. 1 is a cross-sectional view of a transflective display panel including an array substrate according to a first exemplary embodiment of the present invention. As shown in FIG. 1, the array substrate comprising: a backlight source L for emitting light; a substrate 2 including a reflection region R configured to reflect an external light and a transmission region T configured to transmit a light emitted by the backlight source L; and a photoelectric conversion device P disposed on the substrate 2 and configured to convert optical energy of the light emitted from the backlight source L to the reflection region R into electric energy. For example, the converted electric energy may be supplied to the backlight source L.

In the array substrate according to the embodiment of the present invention, because the photoelectric conversion device P performs the photoelectric conversion of optical energy of the light emitted from the backlight source L to the reflection region R into electric energy and then supply of the converted electric energy to the backlight source L. Accordingly, the optical energy of the light incident on the reflection region R of the transflective liquid display device can be recycled to avoid wasting part of energy from the backlight source L.

FIG. 1 shows an embodiment in which the photoelectric conversion device P is disposed in the reflection region R and a vertical projection of the photoelectric conversion device P on the substrate 2 is coincided with a vertical projection of the reflection region R on the substrate 2, in this way, the photoelectric conversion device P can absorb the backlight in the whole reflection region, so that energy of the light that is incident on the reflection region R but does not play a display function is recycled sufficiently. Of course, sizes and position of the photoelectric conversion device P according to the present invention are not limited to those in the embodiment shown in FIG. 1. It is appreciated by those skilled in the art that, in an alternative embodiment, the photoelectric conversion device P may be disposed outside the reflection region R. In this case, provided that conversion of the backlight emitted into the reflection region R is performed by the photoelectric conversion device P, additional components by which the backlight is transported to a light receiving area of the photoelectric conversion device P are required. In another alternative embodiment, lateral size of the photoelectric conversion device P as shown in FIG. 1 can be increased such that a part of the photoelectric conversion device P is extended into the transmission region T. In this way, amount of the received optical energy is increased due to the increased size, however, aperture ratio of the transmission region T is reduced since the extended part of the photoelectric conversion device P in the transmission region T blocks the backlight passing through the transmission region T. In a further alternative embodiment, lateral size of the photoelectric conversion device P as shown in FIG. 1 is reduced to be less than that of the reflection region R such that it is fully located within the reflection region R. In this way, a reduction in the aperture ratio of the transmission region T due to a reduction in the light receiving region of the photoelectric conversion device P can be eliminated, however, the backlight incident on the reflection region R is not sufficiently utilized.

These arrangements of the photoelectric conversion device mentioned in the above embodiments may avoid wasting part of energy from the backlight source. It is appreciated by those skilled in the art that, use of the arrangement in the embodiment shown in FIG. 1 can not only sufficiently utilize the backlight incident on the reflection region R, but also prevent a reduction in the aperture ratio of the transmission region T.

The photoelectric conversion device P may adopt a common thin film semiconductor solar cell structure or an organic fuel solar cell structure. The photoelectric conversion device P in FIG. 1 adopts a common thin film semiconductor solar cell structure, and comprises a N-type silicon layer 9 disposed on a lower electrode 6, an I-type silicon layer 10 disposed on the N-type silicon layer 9, a P-type silicon layer 11 on the I-type silicon layer 10, and an upper electrode 12 disposed on the P-type silicon layer 11, wherein P-type, I-type and N-type silicon layers are named as functional layers configured to convert the optical energy to electron motion. Arrangement order of these silicon layers is not limited the embodiment as shown in FIG. 1, and is variable. For example, it may be, from the top to the bottom, N-type silicon layer, I-type silicon layer and P-type silicon layer, or P-type silicon layer, I-type silicon layer and N-type silicon layer. Those skilled in the art may select the photoelectric conversion device with other configuration in accordance with practical requirements. As shown in FIG. 1, the photoelectric conversion device P comprises a plurality of films that are parallel with each other and formed on the substrate 2. These films form a light receiving surface parallel to the substrate 2, to absorb effectively the backlight emitted from the backlight source L.

FIG. 1 also shows a substrate 1 and a film 1a formed on the substrate 1, which constitute an assembled substrate. The transmission region T of the substrate 2 is formed with the film 2a, and the array substrate comprises the substrate 2, the film 2a provided on the substrate 2, the photoelectric conversion device P, and so on. Moreover, a liquid crystal layer O is filled between the array substrate and the assembled substrate.

Further, the array substrate is provided with a pixel driving circuit comprising a thin film transistors 4, a gate line (not shown in FIG. 1) and a data line (not shown in FIG. 1) and adapted to control a voltage signal applied on each pixel electrode. In the transflective liquid crystal display device shown in FIG. 1, after the array substrate and the assembled substrate are assembled together, the liquid crystal layer O is filled between the two substrates to form a liquid crystal cell. Thickness d of the liquid crystal layer O in the transmission region T is twice as much as thickness d/2 of the liquid crystal layer O in the reflection region R such that optical phase of the light passed through the transmission region T is the same as that of the light reflected by the reflection region R.

In the prior art, the pixel driving circuit is usually disposed in the transmission region, and, a pad layer is formed by filling the substrate located in the reflection region with insulation material such that thickness of the liquid crystal layer in the reflection region is reduced to a half of the thickness of the liquid crystal layer in the transmission region, thereby ensuring that thickness of the liquid crystal layer in the reflection region is reduced to a half of the thickness of the liquid crystal layer in the transmission region.

In the array substrate according to the prior art, when the data line in the pixel driving circuit disposed in the transmission region is energized in use, a parasitic capacitance which affects deflection of liquid crystal molecules above the data line is generated, thereby resulting in light leakage. In order to solve the problem in the display panel according to the prior art, the corresponding pixel driving circuit in the assembled substrate is located at a black matrix 17 as shown in FIG. 8 to block the leaked light, so as to avoid occurrence of bad display, however, provision of the black matrix 17 results in reduction of the aperture ratio of the pixel. FIG. 8 also shows the transmission region 15 and the reflection region 16 which are not covered with the black matrix 17.

In the array substrate according to the embodiment of the present invention, as shown in FIG. 7, the pixel driving circuit is disposed in the reflection region R. Due to provision of a pad layer in the reflection region R, an insulation layer with relatively large thickness may be provided between the data line and the liquid crystal layer O, to reduce effect of the parasitic capacitance on the liquid crystal molecules, thereby avoiding occurrence of light leakage phenomenon. Since there is no light leakage phenomenon, no black matrix should be disposed at a corresponding location to the pixel driving circuit in the assembled substrate, thereby enhancing the aperture ratio in the pixel area. Further, the pixel driving circuit is disposed in the reflection region R such that the light incident on the reflection region R may be converted farthest into electrical energy through the photoelectric conversion device P according to the above mentioned embodiment and the converted electrical energy is supplied to the backlight source, thereby achieving the energy-savings. In addition, provision of both the pixel driving circuit and the photoelectric conversion device P in the reflection region R can optimize the use of free area in the array substrate, which improves energy efficiency without increasing the plane size of the array substrate.

When both the pixel driving circuit and the photoelectric conversion device P are provided in the reflection region R, the photoelectric conversion device P can be superposed with the pixel driving circuit in a direction perpendicular to a surface of the substrate, as shown in FIG. 1 (which only shows a thin film transistor 4 in the pixel driving circuit). In an alternative embodiment, the photoelectric conversion device P can also be juxtaposed with the pixel driving circuit in the direction parallel to the surface of the substrate, as shown in FIG. 2 (which only shows the thin film transistor 4 in the pixel driving circuit). There may be two arrangements provided that the photoelectric conversion device P is superposed with the pixel driving circuit in the direction perpendicular to the surface of the substrate. In a first arrangement shown in FIG. 1, the photoelectric conversion device P is disposed above the pixel driving circuit; while, in the other arrangement shown in FIG. 3, the photoelectric conversion device P is disposed below the pixel driving circuit. In the case that the photoelectric conversion device P is disposed below the pixel driving circuit, films of the pixel driving circuit do not block the light from the backlight source to enter into the reflection region R such that more backlight is absorbed by the photoelectric conversion device P, thereby obtaining more electrical energy. In the case that the photoelectric conversion device P is disposed above the pixel driving circuit, relatively more films are disposed between the pixel driving circuit and the liquid crystal layer O such that effect of the parasitic capacitance on the liquid crystal molecules is greatly impaired.

Since photoelectric conversion efficiency is directly affected by material, PN configuration, lighting receiving area, thickness, etc. of the photoelectric conversion device, material and PN configuration of the photoelectric conversion device may be adjusted in accordance with predetermined thickness, lighting receiving area and desirable photoelectric conversion efficiency. In this way, in the condition of satisfying the thickness of the liquid crystal cell, the maximum photoelectric conversion efficiency and optimal energy-savings effect are achieved.

As shown in the above mentioned embodiment, the array substrate further comprises a pad layer disposed to the reflection region. When the photoelectric conversion device P is superposed with the pixel driving circuit in the direction perpendicular to the surface of the substrate (as shown in FIG. 1 and FIG. 3), the pad layer comprises films of the photoelectric conversion device P and of the pixel driving circuit. Of course, when other films are disposed on the substrate 2 of the reflection region R, the pad layer also comprises these other films. In order to ensure that optical phase of the light reflected by the reflection region R is the same as that of the light passed through the transmission region T, a thickness of the pad layer in the direction perpendicular to the surface of the substrate should be a half of the thickness d of the liquid crystal layer in the array substrate after being assembled. That is to say, when the photoelectric conversion device P is superposed with the pixel driving circuit in the direction perpendicular to the surface of the substrate, films of the photoelectric conversion device P, films of the pixel driving circuit and these other films are superposed together to constitute the pad layer. When the thickness of the pad layer in the direction perpendicular to the surface of the substrate 2 is d/2, it is ensured that optical phase of the light reflected by the reflection region R is the same as that of the light passed through the transmission region T.

When the photoelectric conversion device P is juxtaposed with the pixel driving circuit in the direction perpendicular to the surface of the substrate 2 (as shown in FIG. 2), the pad layer comprises films of the photoelectric conversion device P, and may also comprise films, that are not shared with the photoelectric conversion device P, of the pixel driving circuit and other films disposed on the substrate 2 of the reflection region R, all of which constitutes the pad layer. Thickness of this pad layer in the direction perpendicular to the surface of the substrate should be a half of the thickness d of the liquid crystal layer in the array substrate after being assembled, such that it is ensured that optical phase of the light reflected by the reflection region R is the same as that of the light passed through the transmission region T.

In order to achieve reflection of the external light on the reflection region R, when the photoelectric conversion device P is disposed above the pixel driving circuit, the insulation layer 5 and the reflection layer 3 shown in FIG. 1 are sequentially formed above the photoelectric conversion device P; and when the photoelectric conversion device P is disposed below the pixel driving circuit, the flat layer 13 and the reflection layer 3 shown in FIG. 3 are sequentially formed above the pixel driving circuit.

Generally, the photoelectric conversion device comprises two electrodes, i.e. an upper electrode and a lower electrode, through which electrical energy generated at the photoelectric conversion device is transferred to circuitry connected to the two electrodes. In the embodiment shown in FIG. 1, the photoelectric conversion device P is disposed above the pixel driving circuit, and this photoelectric conversion device P comprises the upper electrode 12 away from the pixel driving circuit and the lower electrode 6 closing to the pixel driving circuit.

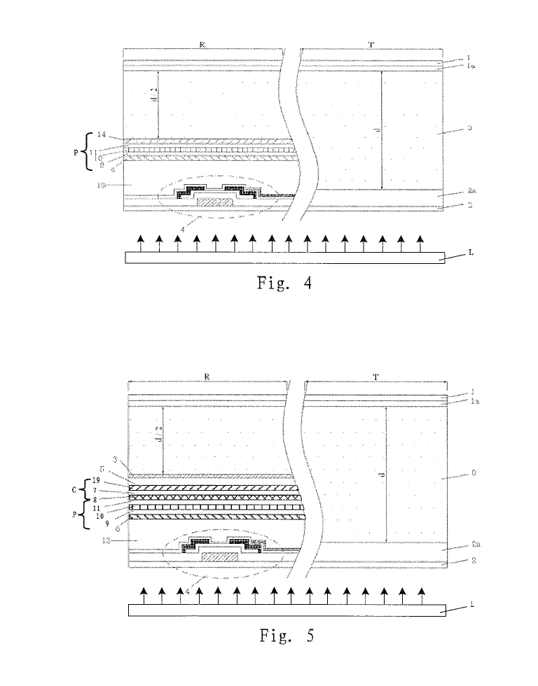

In an exemplary embodiment shown in FIG. 4, a reflection electrode 14, acted as the upper electrode, is made of reflection-type conductive material and constructed to reflect the external light and the light emitted from the backlight source. In this way, a process of manufacturing the reflection layer 3 in the embodiment shown in FIG. 3 may be omitted, and material and process costs is saved. In the embodiment shown in FIG. 4, the lower electrode 6 should be made of transparent conductive material such that the backlight may be directed into a functional layer between the reflection electrode 14 and the lower electrode 6 of the photoelectric conversion device P.

In the embodiment shown in FIG. 3, the photoelectric conversion device P is disposed below the pixel driving circuit, and this photoelectric conversion device P comprises a lower electrode 6 away from the pixel driving circuit and an upper electrode 12 closing to the pixel driving circuit. The lower electrode 6 is made of transparent conductive material such that the backlight may be directed into a functional layer between the upper electrode 12 and the lower electrode 6 of the photoelectric conversion device P. Herein, there is no limitation on the material of which the upper electrode 12 is made.

In the embodiment shown in FIG. 1, the photoelectric conversion device P is disposed above the pixel driving circuit, and in this photoelectric conversion device P, the respective films of the thin film transistor have different patterns. These films with different patterns are superposed together, the surface of a top film of these films is uneven, thereby forming a height difference. In order to achieve an even thickness for the liquid crystal layer, a flat layer 13 may be formed between photoelectric conversion device P and the pixel driving circuit. Such flat layer 13 is made of insulation material and is configured to eliminate the height difference caused by films of the pixel driving circuit. In an alternative embodiment, the height difference caused by films of the pixel driving circuit may be eliminated by setting functional layers between the upper electrode 12 and the lower electrode 6 of the photoelectric conversion device P to have a predetermined thickness.

In the embodiment shown in FIG. 3, the photoelectric conversion device P is disposed below the pixel driving circuit, and the flat layer 13 configured to eliminate a height difference caused by films of the pixel driving circuit and the reflection layer 3 are sequentially formed above the pixel driving circuit.

When the photoelectric conversion device P and the pixel driving circuit are arranged side by side in a direction parallel to the surface of the substrate, as shown in FIG. 2, the flat layer 13 and the reflection layer 3 are sequentially formed above both the pixel driving circuit and the photoelectric conversion device P. The reflection layer 3 is constructed to reflect the external light incident on the reflection region R, and, the flat layer 13 is configured to eliminate the height difference caused by films of the pixel driving circuit.

In the array substrate according to the above mentioned embodiment, as the pixel driving circuit is disposed in the reflection region R, the light emitted by the backlight source goes through the reflection region R and is reflected and scattered among these films of the reflection region R. The reflected and scattered light is incident on a channel area of the thin film transistor in the pixel driving circuit, such that leakage current is generated at the thin film transistor, which leads to bad display. In order to prevent generation of this leakage current, a shading layer (not shown) configured to block the light into the channel area of the thin film transistor in the pixel driving circuit may be disposed on the array substrate. Specific location of the shading layer is determined according to the light receiving position of the channel area in the thin film transistor.

For example, in an exemplary embodiment shown in FIG. 1, the thin film transistor is a bottom gate transistor in which only a transparent insulation layer is covered over the channel area such that the light is apt to go onto the channel area from the above. In order to block the light to be directed into the channel area, a shading layer may be disposed above the channel area. Provided that the thin film transistor is a top gate transistor in which the channel area is apt to be interfered by the light from the bottom, in order to block the light to be directed into the channel area, a shading layer may be disposed below the channel area. Of course, in the thin film transistors with different configurations, their light receiving locations are different, correspondingly, locations of the shading layers may be variable as long as the location of the shading layer can block the light into the channel area.

As an improvement of the array substrate according to these above mentioned embodiments, an array substrate according to a further embodiment comprises an energy storage device configured to store electric energy converted by the photoelectric conversion device. For example, FIG. 5 is a cross-sectional view of a transflective display panel including an array substrate according to a fifth exemplary embodiment of the present invention. In addition to these components contained in the array substrate shown in FIG. 1, the array substrate according to the embodiment shown in FIG. 5 further comprises a first energy storage device C configured to store electric energy converted by the photoelectric conversion device P. Due to provision of such energy storage device, electric energy converted by the photoelectric conversion device P may be stored, and supplied to the backlight source continuously once no electrical energy is supplied from a power supply to the backlight source. The energy storage device may be disposed on the array substrate, or else, may be disposed on the assembled substrate as described in the following embodiment. In order to differentiate these energy storage devices at different locations, herein, the one disposed on the array substrate is named as the “first energy storage device”, while, the one disposed on the assembled substrate is named as the “second energy storage device”.

In one embodiment, the first energy storage device C is located in the reflection region R. In another embodiment, the first energy storage device C is disposed in the transmission region T, and in this case, the first energy storage device C blocks the backlight to pass through the transmission region T, thereby resulting in a reduction of the aperture ratio of the transmission region T. In addition, provided that both the photoelectric conversion device P and the first energy storage device C are disposed in the reflection region, the first energy storage device C may be disposed above the photoelectric conversion device P in the direction perpendicular to and away from the substrate 2 such that incidence of the backlight into the photoelectric conversion device P is not blocked by the first energy storage device C and the light from the backlight source L to the reflection region R may be utilized sufficiently by the photoelectric conversion device P. Of course, the first energy storage device C and the photoelectric conversion device P may be arranged side by side in the direction parallel to the substrate 2, and in this case, incidence of the backlight into the photoelectric conversion device P is also not blocked by the first energy storage device C. However, due to smaller sizes of the first energy storage device C and of the photoelectric conversion device P, it has a reduced energy storage and photoelectric conversion capability compared with the superposed arrangement shown in FIG. 5.

FIG. 5 shows the embodiment in which the first energy storage device C is disposed above the photoelectric conversion device P, and the first energy storage device C is a capacitor. Of course, other suitable electrical energy storage devices available by those skilled in the art may be used as the energy storage device.

In the embodiment shown in FIG. 5, the first energy storage device C comprises an upper storage electrode 19 away from the photoelectric conversion device P, a lower storage electrode 8 closing to the photoelectric conversion device P and a dielectric layer 7 disposed between the two electrodes. The lower storage electrode 8 can be shared by the first energy storage device C and the photoelectric conversion device P. In this way, a step of making one electrode may be omitted, and also, a step of electrically connecting one electrode of the first energy storage device C with one electrode of the photoelectric conversion device P may be omitted.

Accordingly, when the first energy storage device C is disposed above the photoelectric conversion device P, the photoelectric conversion device P is connected to the lower storage electrode 8 on the first energy storage device C, such that electrical connection between the first energy storage device C and the photoelectric conversion device P may be achieved by only forming the lower storage electrode 8.

Similarly, when the first energy storage device is disposed below the photoelectric conversion device, the photoelectric conversion device is connected to the upper electrode on the first energy storage device, such that electrical connection between the first energy storage device and the photoelectric conversion device may be achieved by only forming the upper electrode.

In addition, when the first energy storage device is disposed above the photoelectric conversion device, the electrode (namely, the upper storage electrode 19), that is away from the photoelectric conversion device, of the first energy storage device may be made of reflection conductive material. In this way, a step of forming the reflection layer 3 in the reflection region R above the first energy storage device may be omitted, thereby saving material and process costs.

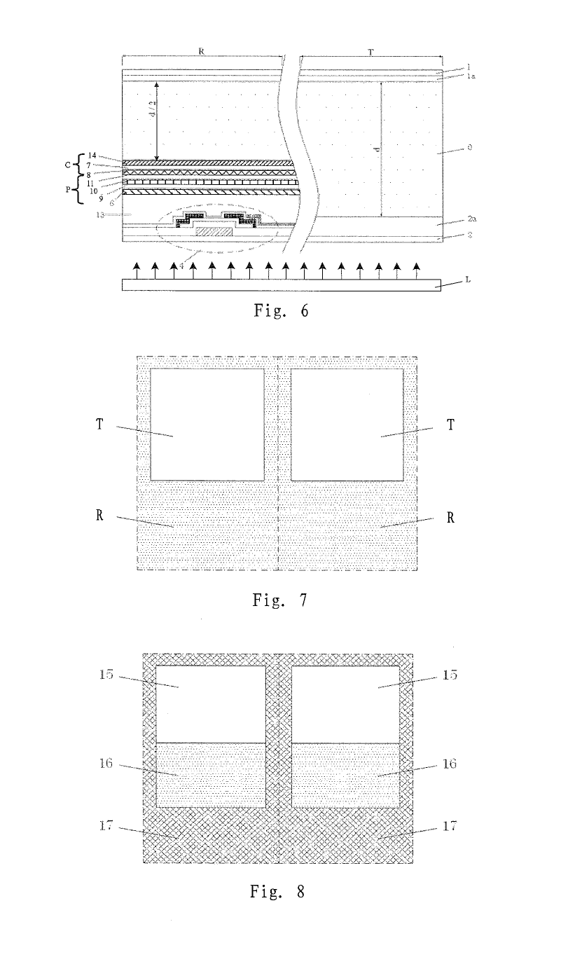

As shown in FIG. 5, when the first energy storage device is disposed above the photoelectric conversion device, in order to allow the reflection region R to reflect the external light, the insulation layer 5 and the reflection layer 3 are formed in the reflection region R above the first energy storage device C. FIG. 6 shows an array substrate substantially the same as that shown in FIG. 5, excepting replacement of the upper storage electrode 19 of the first energy storage device C by the reflection electrode 14 made of reflection conductive material. In the array substrate shown in FIG. 6, a step of forming the reflection layer in the reflection region above the first energy storage device C may be omitted, thereby saving material and process costs.

According to an embodiment of a further aspect of the present invention, there is provided a display panel comprising an assembled substrate and the array substrate according to these above mentioned embodiments.

In the display panel according to the embodiment of the present invention, due to use of the array substrate according to these above mentioned embodiments in which the photoelectric conversion device is configured for photoelectric conversion of optical energy of the light emitted to the reflection region into electric energy so as to supply the converted electrical energy to the backlight source, optical energy of the light incident on the reflection region can be recycled and no energy from the backlight source is wasted, thereby improving energy efficiency of the display panel.

In the display panel according to the above mentioned embodiment, it may further comprise a second energy storage device disposed on the assembled substrate and configured to store electric energy converted by the photoelectric conversion device on the array substrate. Of course, the second energy storage device is required to be electrically connected with the photoelectric conversion device disposed on the array substrate via wires. In addition, the second energy storage device disposed on the assembled substrate may block some of the external light reflected by the reflection region R. In order to eliminate bad display, a shading layer is additionally disposed at the location where the second energy storage device is disposed, thereby reducing aperture ratio of the pixel.

According to embodiments of a further aspect of the present invention, there is provided a display device comprising the array substrate according to the above mentioned embodiments of the present invention. Since this display device adopts array substrate according to the above mentioned embodiments of the present invention, it prevents part of energy from the backlight source to be wasted and increases energy efficiency of the liquid crystal display device.

The display device according to embodiments of the present invention may in particular used in smart mobile terminal equipments such as smart watch and the likes.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An array substrate, comprising:
a backlight source for emitting light;
a substrate including a reflection region configured to reflect an external light and a transmission region configured to transmit a light emitted by the backlight source; and
a photoelectric conversion device disposed on the substrate and configured to convert optical energy of the light emitted to the reflection region into electric energy.

2. The array substrate according to claim 1, wherein the photoelectric conversion device is disposed in the reflection region.

3. The array substrate according to claim 2, wherein a vertical projection of the photoelectric conversion device on the substrate is coincided with a vertical projection of the reflection region on the substrate.

4. The array substrate according to claim 2, further comprising a pixel driving circuit disposed in the reflection region.

5. The array substrate according to claim 4, wherein the photoelectric conversion device and the pixel driving circuit are arranged up and down in a direction perpendicular to a surface of the substrate.

6. The array substrate according to claim 5, further comprising a pad layer disposed in the reflection region and including films of the photoelectric conversion device and of the pixel driving circuit, a thickness of the pad layer in the direction perpendicular to the surface of the substrate being a half of that of a liquid crystal layer of the array substrate after being assembled.

7. The array substrate according to claim 5, wherein the photoelectric conversion device is disposed above the pixel driving circuit and away from the substrate.

8. The array substrate according to claim 7, wherein a flat layer is formed between the photoelectric conversion device and the pixel driving circuit, and is configured to eliminate a height difference caused by films of the pixel driving circuit.

9. The array substrate according to claim 7, wherein an insulation layer and a reflection layer are sequentially formed above the photoelectric conversion device.

10. The array substrate according to claim 7, wherein the photoelectric conversion device comprises:
an upper electrode away from the pixel driving circuit, made of reflection conductive material and configured to reflect the external light and the light emitted by the backlight source; and
a lower electrode closing to the pixel driving circuit and made of transparent conductive material.

11. The array substrate according to claim 7, wherein the photoelectric conversion device further comprises a functional layer disposed between the upper electrode and the lower electrode and having a predetermined thickness to eliminate a height difference caused by films of the pixel driving circuit.

12. The array substrate according to claim 5, wherein the photoelectric conversion device is disposed below the pixel driving circuit.

13. The array substrate according to claim 12, wherein a flat layer configured to eliminate a height difference caused by films of the pixel driving circuit, and a reflection layer are sequentially formed above the pixel driving circuit.

14. The array substrate according to claim 12, wherein the photoelectric conversion device comprises:
a lower electrode away from the pixel driving circuit and made of transparent conductive material; and
an upper electrode closing to the pixel driving circuit.

15. The array substrate according to claim 4, wherein the photoelectric conversion device and the pixel driving circuit are arranged side by side in a direction parallel to a surface of the substrate.

16. The array substrate according to claim 15, further comprising a pad layer disposed in the reflection region and including films of the photoelectric conversion device, a thickness of the pad layer in the direction perpendicular to the surface of the substrate being a half of that of a liquid crystal layer of the array substrate after being assembled.

17. The array substrate according to claim 15, wherein a flat layer configured to eliminate a height difference caused by films of the pixel driving circuit, and a reflection layer are sequentially formed above the photoelectric conversion device and the pixel driving circuit.

18. The array substrate according to claim 4, further comprising a shading layer configured to block a light directed into a channel area of a thin film transistor in the pixel driving circuit.

19. The array substrate according to claim 1, further comprising a first energy storage device configured to store electric energy converted by the photoelectric conversion device.

20. The array substrate according to claim 19, wherein the first energy storage device is disposed in the reflection region.

21. The array substrate according to claim 20, wherein the photoelectric conversion device is provided in the reflection region in a direction perpendicular to and away from the substrate, and the first energy storage device is disposed above the photoelectric conversion device away from the substrate.

22. The array substrate according to claim 21, wherein the first energy storage device comprises:
an upper storage electrode away from the photoelectric conversion device;
a lower storage electrode closing to the photoelectric conversion device; and
a dielectric layer disposed between the upper storage electrode and the lower storage electrode,
wherein the lower storage electrode of the first energy storage device is shared by the first energy storage device and the photoelectric conversion device.

23. The array substrate according to claim 22, wherein the upper storage electrode of the first energy storage device is made of reflection conductive material and configured to reflect the external light and the light emitted by the backlight source.

24. A display device comprising an array substrate comprising:
a backlight source for emitting light;
a substrate including a reflection region configured to reflect an external light and a transmission region configured to transmit a light emitted by the backlight source; and
a photoelectric conversion device disposed on the substrate and configured to convert optical energy of the light emitted to the reflection region into electric energy.
